(19) United States
(12) Patent Application Publication
(10) Pub. No.: US 2008/0230005 A1
(43) Pub. Date: Sep. 25, 2008

(54) Enclosures for and Installations Comprising Curing Means

(76) Inventors: Paul Trevor Jackson, Birmingham (GB); Stephen Andrew Byrne, Worcestershire (GB)

Correspondence Address: NIXON & VANDERHYE, PC, 901 NORTH GLEBE ROAD, 11TH FLOOR, ARLINGTON, VA, 22203, US

(21) Appl. No.: 12/067,116

(22) PCT Filed: Sep. 15, 2006
(86) PCT No.: PCT/GB06/03459

§ 371 Date: Mar. 17, 2008

(30) Foreign Application Priority Data
Sep. 17, 2005 (GB) 0519037.6

(51) Int. Cl. B05C 9/08

(52) U.S. Cl. 118/692

(57) ABSTRACT

An openable enclosure for use in association with an enclosed work-area defining a workspace provided with application means for applying a curable composition such as a UV curable composition to a workpiece, the enclosure comprising an openable cover which is operable between open and closed conditions respectively to open and close the enclosure to an interior of the work-area, the enclosure defining a space within which a radiation source is removably stowed, and the cover having locking means to permit of locking the cover in the closed condition.

This application relates to an openable enclosure for curing means such as a radiant light source and to installations which may be provided with such enclosures. For example, such installation may be a work-room, workshop or coating booth in which a curable composition such as a radiant cured composition, is applied to a workpiece and is subsequently cured by exposure to radiation, such as to UV radiation.

It particularly, but not exclusively, relates to spray coating installations in which the sprayed composition is a UV curable coating such as a lacquer or paint and the lacquer or paint is applied to the workpiece by means of known spraying equipment in a known or modified spray booth.

It is known to provide sprayable compositions typically of paint which are curable by exposure of the applied composition to ultra violet radiation. It is also known to spray such compositions onto a workpiece and then to cure the paint by exposing the sprayed workpiece to UV radiation. However this process can be hazardous unless carried out under strictly controlled conditions, because operation (of especially high powered) UV sources in an atmosphere laden with inflammable vapour and/or airborne paint or solvent droplets carries a risk of explosion.

Usually the UV source is kept outside of a spray booth during spraying for safety reasons. A venting of airborne spray composition is then carried out to purge the booth of potentially explosive vapours and when purging is completed to safe level, the UV source is brought into the spray booth and used to cure the composition. It is then taken out of the booth again so that a further spraying operation can be carried out. The UV equipment therefore must be repeatedly moved into and out of the booth by an operator in between spraying operations. This is inefficient and capable of improvement.

It is nonetheless economically desirable for the spray operator to have a UV source readily to hand within the booth but for safety reasons this has not been possible.

The use of UV sources of low power which are less likely to initiate explosion is undesirable because such sources are less effective at curing UV curable paint or lacquer. Moreover, when it is necessary or desired to use a UV source to cure paint, the UV source must not only be brought into the booth from outside the booth but it must also be powered up from a cold starting condition. There is a time delay until the UV source has reached a power which is suitable for curing the paint. This further takes time and it would be desirable to manage this time delay in a more efficient manner whilst maintaining safe operating conditions.

It is an object of the present invention to provide a means by which e.g. a UV source is conveniently made available to an operator within a paint spraying booth, such that the UV source is ready for use in curing the paint after a minimum delay following completion of paint spraying but in which the UV source is inaccessible to the operator until the hazard from explosion has been preferably eliminated or otherwise satisfactorily minimised.

In a first aspect the invention comprises an openable enclosure for use in association with an enclosed work-area such as a workroom, workshop or coating booth defining a workspace provided with application means for applying a curable composition to a workpiece, the enclosure comprising an openable cover operable between open and closed conditions respectively to open and close the enclosure to an interior of the work-area, the enclosure defining a space within which a radiation source is removably stowed, and the cover having locking means to permit of locking the cover in the closed condition.

The openable enclosure may be a cabinet and the openable cover thereof may be a door, wall or window of such preferred cabinet. The curable composition is preferably UV curable and the radiation source is preferably UV radiation such as a main powered UV lamp.

Preferably the locking means maintains the cover in a closed condition unless the interior of the work-area is wholly or substantially purged of vapours and airborne droplets of the composition.

Preferably the enclosed work-area includes purge means, by activation of which vapours and airborne droplets of the composition are removed from within the interior of the enclosed work-area.

The purge means may conveniently comprise a known ventilation device.

Preferably, the openable cover locking means is operatively associated with timer means which timer means effects release of the locking means after a predetermined time has elapsed following activation of the purge means.

More preferably, the predetermined time measured by the timer is adjustable.

Alternatively, either one or both of the enclosed work-areas and the openable enclosure includes sensor means which are sensitive to at least one of composition vapours and airborne droplets of the composition, and the sensor means are operatively associated with the locking means to maintain the openable cover in a closed condition until the level of composition vapours and/or airborne droplets of composition has fallen below a predetermined threshold level.

Preferably, curable composition application means, such as spray coating means, are provided within a workspace of the work-area operatively associated with the locking means to maintain the openable cover in a closed condition when the said curable composition application means is actuated to apply the composition to a workpiece, such as a car body panel.

Preferably, such curable composition application means is operatively associated with the locking means by control means adapted to prevent actuation of the application means when the openable cover is in the open condition.

Most preferably, the application means is a spray gun and the work-area is an enclosed work room such as a spraying booth.

The control means may be adapted to prevent feed of compressed gas to the spray gun.

Preferably, the openable enclosure is a cabinet which is subject to a positive pressure of gas and most preferably the gas is air.

The positive pressure of gas may be applied constantly when the work-area is in use. Optionally, activation of the purge means automatically initiates power-up of the UV radiation source.

Alternatively, power-up of the UV radiation source is initiated manually by a manually operable switch.

Preferably, the UV radiation source includes cooling means by operation of which the operating temperature of the UV radiation source is mediated, and in which the operation of the cooling means is delayed following the initiation of power-up of the UV radiation source.

The delay may be predetermined by a timer element which is operatively associated with activation means to activate the cooling means.

Alternatively, or additionally the UV radiation source includes a temperature sensor for sensing the temperature of the UV radiation source, the temperature sensor being operatively associated with activation means to activate the cooling means, such that the activation means commences operation of the cooling means when the UV radiation source reaches a pre-set threshold temperature.

Most preferably, the cooling means is a fan and the activation means of the cooling means is a motor which drives the fan.

The work-area or work-space thereof may house UV radiation-proof protective wear, such as a face shield.

Preferably, the UV radiation source is provided with connection means to permit its connection to a power source optionally remote from the openable enclosure for powering-up the UV radiation source.

More preferably, such power source is connected with the connection means through a power link provided in a wall of the openable enclosure.

Most preferably, the connection means is a power supply cable.

The openable enclosure may include reeling means to provide for powered reel-up of such a power supply cable into a stowed condition.

The openable enclosure may further comprise a manually operable emergency stop actuator.

The openable enclosure may comprise a first indicator for indicating that the UV radiation source is powering up and a second indicator for indicating that the UV radiation source has reached a power level which is suitable for use in curing the composition.

The openable enclosure further may comprise an at least partly removable drawer in which drawer is housed electronics and control means by which at least one of enclosure operations and work-area operations are managed.

Preferably the control means are operated through computer programs.

The drawer may have a lock which may be actuated to lock or unlock the drawer.

Preferably the composition is a UV curable paint.

In a second aspect the invention comprises an installation for application to a workpiece of a curable composition such as UV curable composition and for curing of the same, the installation comprising an openable enclosure as defined hereinabove.

Preferably, a conventional door is provided in a wall of the installation and the enclosure is recessed in a wall, said door or the floor of such installation.

In a third aspect the invention comprises an installation for applying a UV curable composition onto a workpiece, which installation comprises a booth in the interior of which the workpiece is positioned for application of the composition, a UV radiation source, the UV radiation source being removably stowed in such an openable enclosure as aforesaid, in which it is isolated from an interior of the booth, and an openable cover operable between open and closed conditions respectively to permit of access to the UV radiation source and to isolate the UV radiation source from the interior of the booth.

Preferably, operation of the said openable cover between open and closed conditions is operatively associated, through first control means, with actuation of a curable composition application tool, such that actuation of the application tool to apply the composition to the workpiece and simultaneous opening of the cover are prevented.

Most preferably, the application tool is a spray gun

Alternatively or additionally, operation of the openable cover between open and closed conditions may be operatively associated, through second control means with an actuator for actuation of purge means, by which purge means at least one of composition vapours and airborne droplets of the composition are removed from the booth, such that opening of the cover is possible only after actuation of the purge means.

Preferably, opening of the cover is possible only after a pre-determined time has elapsed from initiation of the purge.

Alternatively or additionally, operation of the cover between open and closed conditions is operatively associated, through third control means, with sensor means, which sensor means are sensitive to at least one of composition vapour or airborne droplets of the composition, whereby opening of the cover is possible only after levels of the at least one of composition vapour or airborne droplets of composition have fallen below a pre-set threshold value, as measured by the sensor means.

Alternatively or additionally, operation of the cover between open and closed conditions is operatively associated, through fourth control means, with power means for powering up the UV radiation source, such that opening of the cover is not possible until the power level of the UV radiation source has reached a predetermined threshold value as measured by power measuring means.

Preferably, the status of the power level of the UV radiation source is indicated to an operator of the installation by indicator means.

Alternatively or additionally, the enclosure is subjected, through pressurising means, to a positive pressure of gas, and in which actuation of a composition application tool, which tool is provided within e.g. the booth, is operatively associated, through fifth control means, with the pressurising means, such that actuation of the composition application tool is possible only if the pressurising means is active to subject the enclosure to a positive pressure of gas.

In a fourth aspect, the invention comprises an installation for applying a UV curable composition onto a workpiece and curing it comprising a composition application tool and a UV radiation source which are operatively linked by control means such that simultaneous actuation of the composition application tool and powering up of the UV radiation source can be prevented.

In a fifth aspect, the invention comprises an installation for applying a UV curable composition onto a workpiece comprising an enclosed work-area such as a booth, a composition application tool within a workspace defined by the work-area, and purge means by which at least one of composition vapour and airborne droplets of composition can be removed from the workspace, in which simultaneous actuation of the composition application tool and the purge means can be prevented.

In order that the invention may be illustrated, more easily appreciated and readily carried into effect by those skilled in the art, an embodiment thereof will now be described purely by way of non limiting example with reference to the accompanying drawings, wherein:

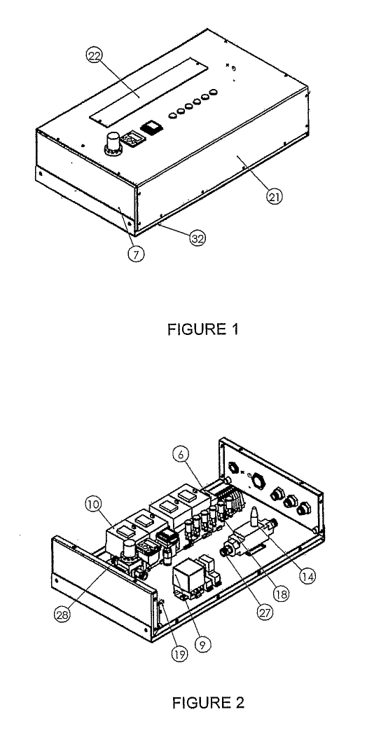

FIG. 1 shows a control box in accordance with the invention

FIG. 2 shows the same control box with the lid removed

Provided within a paint spraying booth are:—
a paint spraying apparatus, adapted to spray UV curable paint and/or lacquer;
an air venting purge system for withdrawing air and volatilised paint from the booth, and, a cabinet in which is removably stowed a compact, lightweight (around 1.5 kg), durable UV hand lamp. The cabinet is located partly recessed within a door of the spraying booth such that the cabinet can be accessed from within the workspace inside the spray booth. The UV hand lamp is protected from dust ingress and has a filter glass assembly fitted to a hinged front, enabling easy access for the UV bulb and filter glass replacement/cleaning. The filter glass itself is of a clear UV-B type.

The cabinet has its own door provided with a lock such that the door is openable by an operator only under circumstances which are outlined below.

The cabinet is positively pressurised by air so that ingress of volatilised paint into the cabinet interior is prevented or minimised.

The UV hand lamp operates at 135 Volts and is connected via a power supply cable to a power supply through a wall of the cabinet, which wall provides a socket for a plug on the power supply cable. The power supply cable is conveniently reeled up onto a reel by a powered reeling mechanism. The UV hand lamp can thus be deployed from the cabinet by opening the cabinet door, and it can be returned to the cabinet for storage after use, and for subsequent re-use. The connecting cable for the UV hand lamp should be of sufficient length to permit use of the UV hand lamp anywhere in the spray booth. The connecting cable is ideally stored on a reel with ratchet system and spring return.

The cabinet is provided with two indicator lights of different colours, one for indicating that the UV lamp is powering up and the other for indicating that the lamp has reached an optimum power level most suitable for curing UV curable paint.

The cabinet is also provided with an emergency stop button, actuation of which cuts the power supply to the UV hand lamp. The UV hand lamp is further arranged to have an auto reset thermal cut out in the event of its overheating.

Electronics by which cabinet operations, and operations within the spray booth more generally, are managed and co-ordinated are located in a lockable drawer in the cabinet, beneath the UV hand lamp and accessible from the exterior of the spray booth. The components of the electronic control means are known and within the capability of one skilled in the art to construct. One such arrangement is shown in FIGS. 1 and 2. The control box 7 has a lid 21 with display 22. The box 7 may be mounted in a drawer by fixing plate 32. The interior of the box 7 shows an array of contactors 10, connector fittings 27, 28 and rectifier circuit 9. An air-conditioning fan (not shown) may be mounted on socket 19 and the status of the apparatus can be displayed by LED lights 18. Flow of current can be controlled by flow switch 14. For example, where the cabinet is located at the side of the door of a spray booth, as in this embodiment, the drawer of electronic components and circuitry can be withdrawn externally of the booth from the remote side of the booth door. Unlocking and opening this drawer permits convenient access to the electronics for repair or maintenance purposes.

The cabinet also contains a UV radiation-proof face shield for use by the operator when using the UV hand lamp.

The cabinet could alternatively be recessed in a wall of the booth or it can be locked to a floor of the booth, or it can be free standing within the booth, that is mobile for moving around the booth.

The operation of elements of the booth and cabinet are governed by the electronics such that combinations of operations which would be potentially hazardous are prevented, and such that operations are sequentially and temporally ordered so as to minimise risk of explosion. It is preferable that only one action is needed to unlock the cabinet.

The management of operations is executed through a computer program which governs that supply of compressed air to a spray gun of the spray apparatus is prevented when:—
the cabinet door is open, and/or
power supply to the UV hand lamp is active, and/or
the purge system is actively purging the booth, and/or
there is a failure in the air supply to the cabinet so that it is not pressurised.

The management of operations may alternatively or additionally govern that the cabinet door is maintained locked in a closed condition when:—
the spray apparatus is operative to spray paint, and/or
the power supply to the UV hand lamp is active but the lamp has not reached a power level which is suitable for curing paint, and/or
the purge system has not adequately purged the booth of volatilised paint.

Adequacy of purging may be determined by sensors which measure the level of volatilised paint and feedback this information to the control electronics. It may alternatively or additionally be determined by means of a timer which measures an elapsed time since activation of the purge system, a predetermined time being programmed for adequate purging of the booth.

It is desirable for safety reasons that powering up of the UV hand lamp should not commence unduly early whilst there is any risk of explosion. However it takes time for the UV hand lamp to power up to a level of power which is suitable for curing paint, so in order that the operator need not wait a long time for the lamp to be ready for use, it is desirable that, once power up has commenced, the lamp should power up rapidly. To this end a fan which mediates the operating temperature of the lamp is controlled so as to cut in only after a delay following commencement of powering up. The delay is a pre-programmed timed delay. Additionally or alternatively a thermostat may be provided in the lamp to cause the fan to cut in only when a certain pre-set temperature of the lamp has been achieved. It is preferable that the UV hand lamp includes an hour counter for displaying the number of hours the UV bulb has been in use, so it can be seen when the UV bulb will need changing. The bulb itself is preferably a 400 W ozone free bulb with a bulb life of about 300 hours. It is envisaged that the lamp is capable of operating at less than 70 dB of sound.

1. An openable enclosure for use in association with an enclosed work-area defining a workspace provided with application means for applying a curable composition such as a UV curable composition to a workpiece, the enclosure comprising an openable cover which is operable between open and closed conditions respectively to open and close the enclosure to an interior of the work-area, the enclosure defining a space within which a radiation source is removably stowed, and the cover having locking means to permit of locking the cover in the closed condition.

2. An enclosure according to claim 1, in which the locking means maintains the cover in a closed condition unless the interior of the workspace is wholly or substantially purged of vapours and/or airborne droplets of the composition.

3. An enclosure according to claim 1, in which the work-area includes purge means, by activation of which vapours and/or airborne droplets of the composition are removed from the interior of the workspace.

4. An enclosure according to claim 3, in which the purge means comprises a ventilation device.

5. An enclosure according to claim 3, in which the locking means is operatively associated with timer means which timer means effects release of the locking means after a predetermined time has elapsed following activation of the purge means.

6. An enclosure according to claim 5, in which the predetermined time measured by the timer is adjustable.

7. An enclosure according to claim 1, in which either one or both of the work-areas and the enclosure provides sensor means which are sensitive to at least one of composition vapours and airborne droplets of the composition, and the sensor means are operatively associated with the locking means to maintain the openable cover in a closed condition until the level of said at least one of composition vapours and airborne droplets of composition has fallen below a predetermined threshold level.

8. An enclosure according to claim 1, which the curable composition application means is operatively associated with the locking means to maintain the openable cover in a closed condition when the application means is actuated to apply the composition to the workpiece.

9. An enclosure according to claim 1, in which the application means is operatively associated with the locking means by control means which control means prevent actuation of the application means when the openable cover of the said enclosure is in the open condition.

10. An enclosure according to claim 1, in which the application means is a spray gun and the enclosed work-area is a spraying booth.

11. An enclosure cabinet according to claim 9, which the control means prevents feed of compressed gas to the spray gun.

12. An enclosure according to claim 1, which is subject to a positive pressure of gas.

13. An enclosure according to claim 11, in which the gas is air.

14. An enclosure according to claim 12, in which the positive pressure of gas is applied constantly when the workspace is in use.

15. An enclosure according to claim 3, in which activation of the purge means automatically initiates power-up of the radiation source which is a UV radiation source.

16. An enclosure according to claim 1, in which power-up of the UV radiation source is initiated manually by a manually operable switch.

17. An enclosure according to claim 1, in which the UV radiation source includes cooling means by operation of which the operating temperature of the UV radiation source is mediated, and in which the operation of the cooling means is delayed following the initiation of power-up of the UV radiation source.

18. An enclosure according to claim 17, in which the delay is predetermined by a timer element which is operatively associated with activation means to activate the cooling means.

19. An enclosure according to claim 17, in which the UV radiation source includes a temperature sensor for sensing the temperature of the UV radiation source, the temperature sensor being operatively associated with activation means to activate the cooling means, such that the activation means commences operation of the cooling means when the UV radiation source reaches a pre-set threshold temperature.

20. An enclosure according to claim 17, in which the cooling means is a fan and the activation means of the cooling means is a motor which drives the fan.

21. An enclosure according to claim 1, which the interior houses UV radiation-proof protective wear.

22. An enclosure according to claim 21, in which the protective wear comprises a face shield.

23. An enclosure according to claim 1, in which the UV radiation source is provided with connection means to permit connecting the UV radiation source to a power source for powering-up the UV radiation source.

24. An enclosure according to claim 23, in which the power source is connected with the connection means through a power link provided in a wall of the enclosure.

25. An enclosure according to claim 23, in which the connection means is a power supply cable.

26. An enclosure according to claim 25, which includes reeling means to provide for powered reel-up of the cable into a stowed condition.

27. An enclosure according to claim 1, which further comprises a manually operable emergency stop actuator.

28. An enclosure according to claim 1, which further comprises a first indicator for indicating that the UV radiation source is powering up and a second indicator for indicating that the UV radiation source has reached a power level which is suitable for use in curing the composition.

29. An enclosure according to claim 1, which further comprises a drawer in which drawer is housed electronics and control means by which at least one of enclosure operations and work-area operations are managed.

30. An enclosure according to claim 29, in which the control means are operated through computer programs.

31. An enclosure according to claim 29, in which the drawer has a lock which may be actuated to lock or unlock the drawer.

32. An enclosure according to claim 1, in which the composition is a UV curable paint.

33. An installation for application to a workpiece of a UV curable composition and for curing of the same, the installation comprising an openable enclosure together with an enclosed work-area as defined in claim 1.

34. An installation according to claim 33, in which a door is provided in a wall of a work-area within the installation and the enclosure is recessed in the wall, the door or the floor of said work-area.

35. An installation for applying a UV curable composition onto a workpiece comprising an enclosed work-area such as a spray booth in the interior of which a workpiece can be positioned for application of the composition, a UV radiation source, the UV radiation source being removably stowed in an openable enclosure which is isolated from an interior of the booth, and an openable cover operable between open and closed conditions respectively to permit of access to the UV radiation source and to isolate the UV radiation source from the interior of the booth.

36. An installation according to claim 35, in which operation of the cover between open and closed conditions is operatively associated, through first control means, with actuation of an application tool, such that actuation of the application tool to apply the composition to the workpiece and opening of the cover simultaneously are prevented.

37. An installation according to claim 35, in which the application tool is a spray gun

38. An installation according to claim 35, in which operation of the cover between open and closed conditions is operatively associated, through second control means with an actuator for actuation of purge means, by which purge means at least one of composition vapours and airborne droplets of the composition are removed from the booth, such that opening of the cover is possible only after actuation of the purge means.

39. An installation according to claim 38, in which opening of the cover is possible only after a pre-determined time has elapsed from initiation of the purge.

40. An installation according to claim 35, in which operation of the cover between open and closed conditions is operatively associated, through third control means, with sensor means, which sensor means are sensitive to at least one of composition vapour or airborne droplets of the composition, whereby opening of the cover is possible only after levels of the at least one of composition vapour or airborne droplets of composition have fallen below a pre-set threshold value, as measured by the sensor means.

41. An installation according to claim 35, in which operation of the cover between open and closed conditions is operatively associated, through fourth control means, with power means for powering up the UV radiation source, such that opening of the cover is not possible until the power level of the UV radiation source has reached a predetermined threshold value as measured by power measuring means.

42. An installation according to claim 35, in which the status of the power level of the UV radiation source is indicated by indicator means.

43. An installation according to claim 35, in which the enclosure is subjected, through pressurising means, to a positive pressure of gas, and in which actuation of a composition application tool, which tool is provided within the work-area, is operatively associated, through fifth control means, with the pressurising means, such that actuation of the composition application tool is possible only if the pressurising means is active to subject the enclosure to a positive pressure of gas.

44. An installation for applying a UV curable composition onto a workpiece and curing it comprising a composition application tool and a UV radiation source which are operatively linked by control means such that actuation of the composition application tool and powering up of the UV radiation source simultaneously can be prevented or controlled.

45. An installation for applying a UV curable composition onto a workpiece comprising an enclosed work-area, a composition application tool within the work-area, and purge means by which at least one of composition vapour and airborne droplets of composition can be removed from the work-area, in which actuation of the composition application tool and the purge means simultaneously can be prevented or controlled.
